(19) United States
(12) Patent Application Publication
(10) Pub. No.: US 2026/0086010 A1
(43) Pub. Date: Mar. 26, 2026

(54) DETECTION DEVICE AND DETECTION METHOD FOR TESTING MECHANISM

(71) Applicant: SILICONWARE PRECISION INDUSTRIES CO., LTD., Taichung City (TW)

(72) Inventors: Hsi-Chih CHEN, Taichung City (TW); Ming-Jen LIN, Taichung City (TW); Hsun-Yung CHO, Taichung City (TW); Ling-Fei CHENG, Taichung City (TW); Tsung-Te TSAI, Taichung City (TW)

(73) Assignee: SILICONWARE PRECISION INDUSTRIES CO., LTD., Taichung City (TW)

(21) Appl. No.: 18/936,747

(22) Filed: Nov. 4, 2024

(30) Foreign Application Priority Data
Sep. 20, 2024 (TW) 113135804

(51) Int. Cl. G01N 7/00

(52) U.S. Cl. CPC G01N 7/00

(57) ABSTRACT

A detection device and a detection method for a testing mechanism are provided. The testing mechanism includes an air bag and a testing head. The testing head is used to grab an electronic element. The air bag is used to push the testing head when inflated to press the electronic element into a test socket of a testing machine to conduct a power-on testing of the electronic element. The detection device and the detection method can detect whether the air pressure in the air bag is normal, and can detect whether the testing head is level, in order to determine whether the testing mechanism can accurately conduct the power-on testing, so as to solve the shortcomings in that a warning cannot be issued and thus the power-on testing is inaccurate when the air bag leaks or the testing head is tilted in the conventional testing mechanism.

### BACKGROUND

### 1. Technical Field

The present disclosure relates to a detection technology of a testing mechanism of an electronic element, and more particularly, to a detection device and a detection method for a testing mechanism.

### 2. Description of Related Art

FIG. 1A is a partial cross-sectional schematic view of a conventional testing mechanism 1 for a semiconductor chip 14. The semiconductor chip 14 needs to be powered on and tested after its fabrication is completed. To this end, as shown in FIG. 1A, a testing head 13 of the testing mechanism 1 will suck the semiconductor chip 14, and then press the semiconductor chip 14 downward into a test socket 15, so that the semiconductor chip 14 is electrically connected to circuit pins 16 of the test socket 15 for power-on testing.

In order to press the semiconductor chip 14 down into the test socket 15, a rubber air bag 12 must be inflated via a gas pipeline 11 of the testing mechanism 1 to expand the rubber air bag 12. Then, the testing head 13 is pressed downward, and the semiconductor chip 14 is pressed down and fixed in the test socket 15.

However, long-term high-temperature operation of the testing mechanism 1 may cause the rubber material of the rubber air bag 12 to harden or crack, thereby causing it to rupture and leak when inflated.

For example, as shown in FIG. 1B, a rupture point 121 of the rubber air bag 12 leaks during inflation, causing uneven air pressure, causing the testing head 13 to tilt, so that the semiconductor chip 14 is tilted accordingly and cannot correctly connect to the circuit pins 16 of the test socket 15. Moreover, the conventional testing mechanism 1 does not have corresponding detection or warning functions, resulting in inaccurate power-on testing of the semiconductor chip 14.

Therefore, how to overcome the above-mentioned deficiencies in the prior art has become a technical problem that needs to be solved urgently.

### SUMMARY

In order to solve the above problems, the present disclosure provides a detection device for a testing mechanism, and the detection device comprises a gas pipeline, an air pressure sensor, a display and a height sensor. The testing mechanism includes an air bag and a testing head, wherein the testing head is used to grab an electronic element, and the air bag is used to push the testing head when inflated to press the electronic element into a test socket of a testing machine to perform a power-on testing of the electronic element. The gas pipeline is used for inflating the air bag. The air pressure sensor is used for sensing an air pressure in the air bag. The display is used for displaying a value of the air pressure. The height sensor is used for sensing a height of the testing head.

The present disclosure further provides a detection method for the aforementioned testing mechanism, and the detection method comprises: inflating the air bag; sensing an air pressure in the air bag; displaying a value of the air pressure; and sensing a height of the testing head.

In the detection device and detection method of the testing mechanism according to the present disclosure, the present disclosure can detect whether the air bag pressure of the testing mechanism is normal, and can detect whether the testing head of the testing mechanism is level according to the height of the testing head. Therefore, a warning is issued when the air bag pressure is insufficient or the testing head is not level to detect whether the testing mechanism can accurately conduct the power-on testing of the electronic element, so as to solve the shortcomings in that a warning cannot be issued and thus the power-on testing is inaccurate when the air bag leaks or the testing head is tilted in the conventional testing mechanism.

### BRIEF DESCRIPTION OF THE DRAWINGS

FIG. 1A and FIG. 1B are partial cross-sectional schematic views of a conventional testing mechanism for a semiconductor chip.

FIG. 2 is a flowchart of a detection method for a testing mechanism according to the present disclosure.

FIG. 3A and FIG. 3B are schematic cross-sectional views of the testing mechanism according to the present disclosure.

FIG. 3C and FIG. 3D are schematic views of a detection device of the testing mechanism according to the present disclosure.

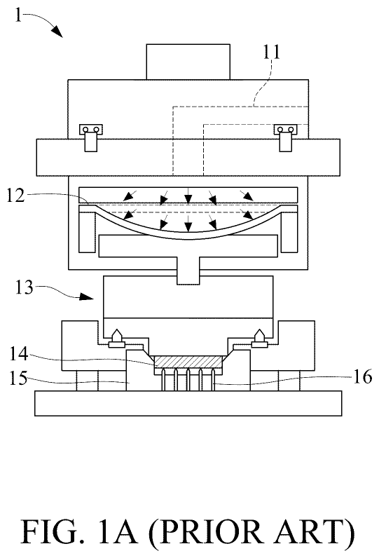

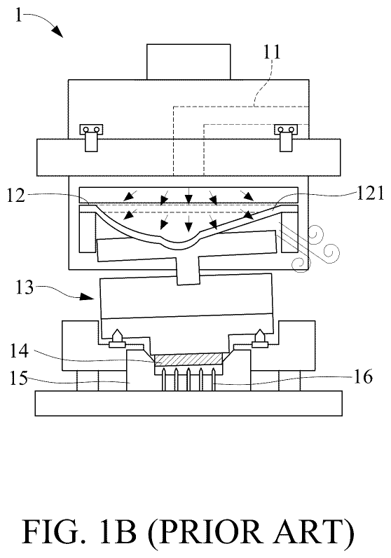

### DETAILED DESCRIPTION

The following describes the embodiments of the present disclosure with examples. Those skilled in the art can easily understand other advantages and effects of the present disclosure from the contents disclosed in this specification.

It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable proposes should still be deemed as falling within the scope defined by the technical contents disclosed in the present specification. Meanwhile, terms such as “on,” “upper,” “below,” “lower,” “one,” “a,” “first,” “second,” and the like are for clear explanation rather than limiting the practicable scope of the present disclosure, and thus, alterations or adjustments of the relative relationships thereof without essentially altering the technical contents should still be considered in the practicable scope of the present disclosure.

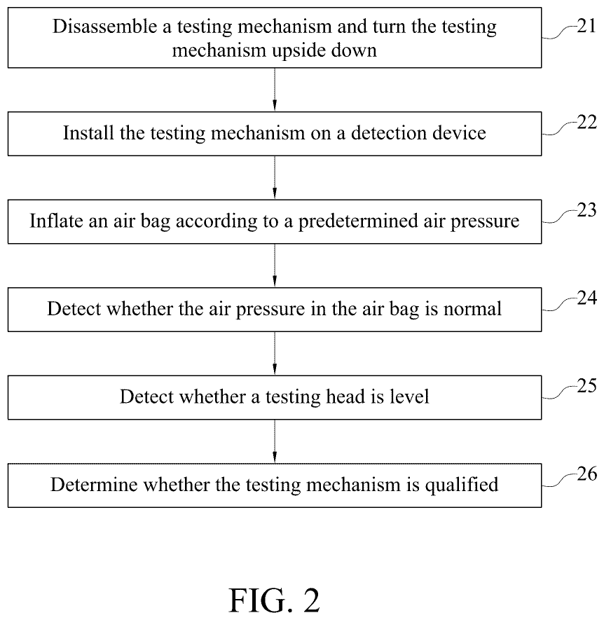

FIG. 2 is a flowchart of a detection method of a testing mechanism according to the present disclosure. First, in step 21, a testing mechanism is disassembled from an electronic element testing machine and the testing mechanism is turned upside down.

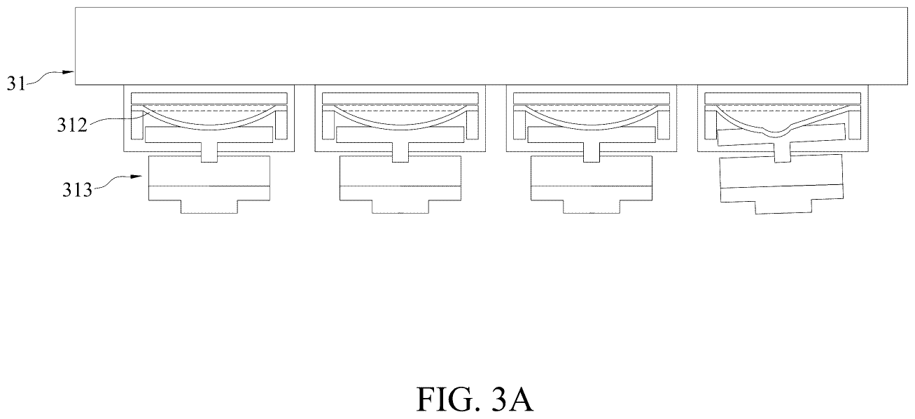

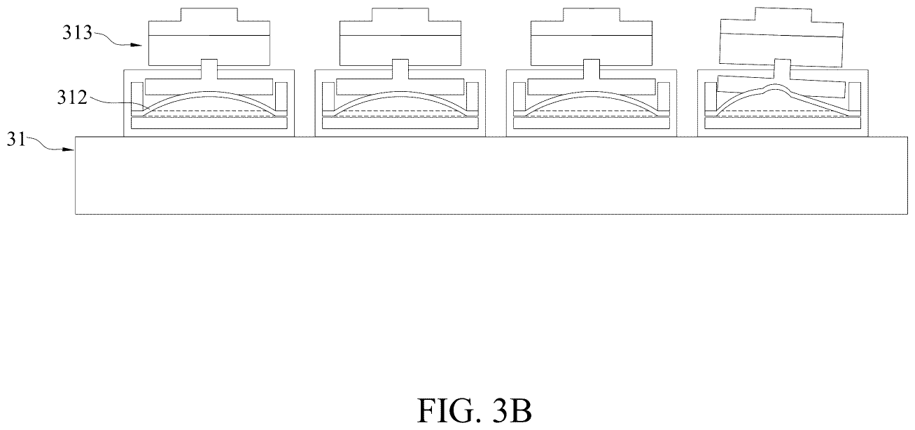

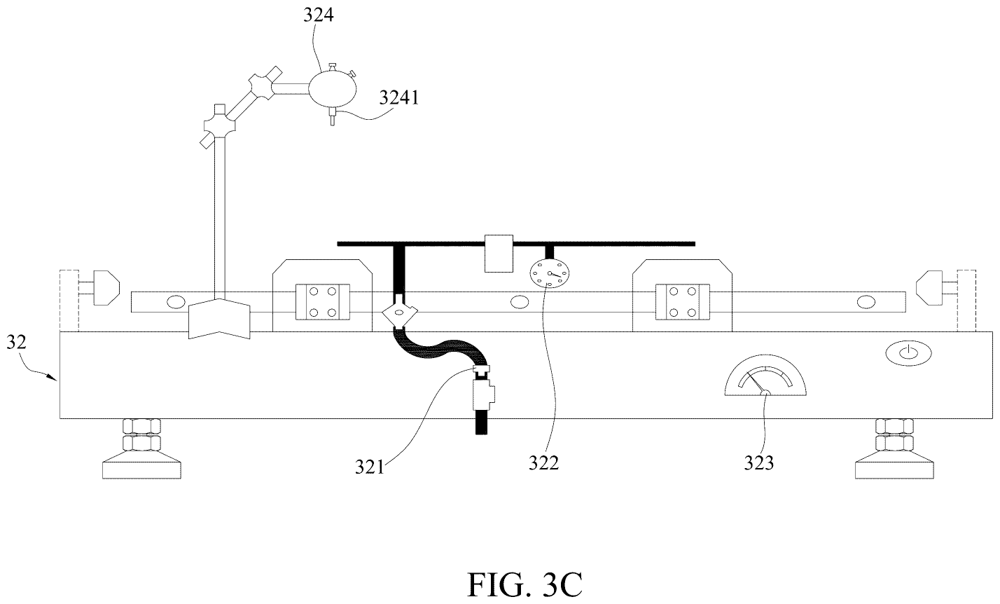

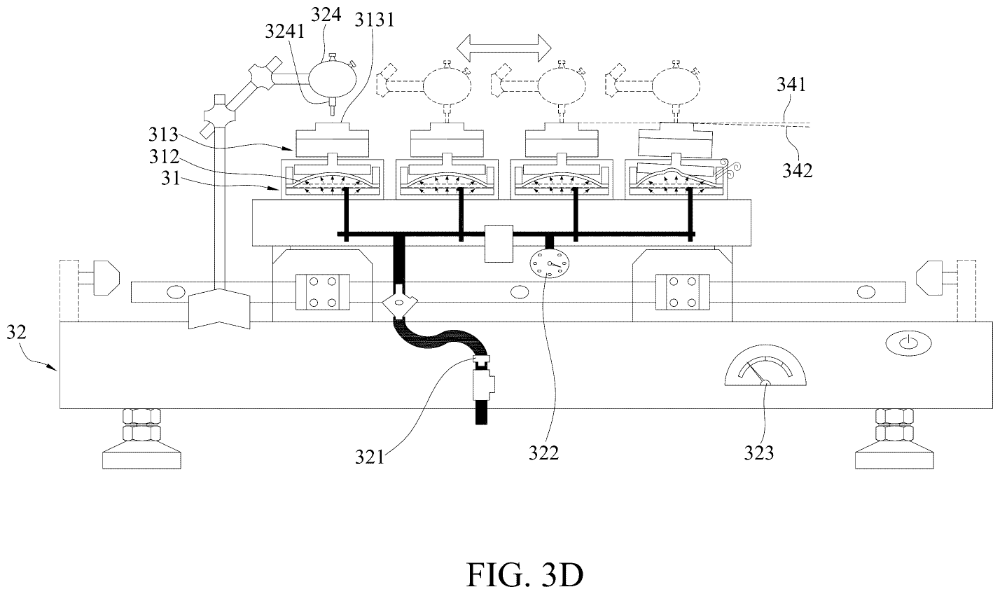

Please refer to FIG. 3A and FIG. 3B at the same time. FIG. 3A is a schematic cross-sectional view of the testing mechanism (i.e., a testing mechanism 31) after it is disassembled from the testing machine, and FIG. 3B is a schematic cross-sectional view of the testing mechanism 31 after it is turned upside down.

The testing mechanism 31 includes at least one air bag 312 and at least one corresponding testing head 313. The illustration of this embodiment shows multiple air bags 312 and corresponding multiple testing heads 313. For example, the air bags 312 may be made of rubber. The testing heads 313 are used to grab an electronic element, for example, using a vacuum suction method to grab the electronic element. The air bags 312 are used to push the testing heads 313 when inflated, so as to press the electronic element into the test socket of the testing machine, so as to perform the power-on testing of the electronic element.

The electronic element can be an active element, a passive element, or a combination of the active element and the passive element. The active element is, for example, a semiconductor chip, and the passive element is, for example, a resistor, a capacitor, or an inductor.

In step 22, the testing mechanism 31 is installed on a detection device of the testing mechanism.

Please refer to FIG. 3C and FIG. 3D at the same time. FIG. 3C is a schematic view of a detection device 32 of the testing mechanism 31 according to the present disclosure, and FIG. 3D is a schematic view of the testing mechanism 31 being installed on the detection device 32 for detection. The detection device 32 includes a gas pipeline 321, an air pressure sensor 322, a display 323 and a height sensor 324. The air pressure sensor 322 is connected to the gas pipeline 321, and the display 323 is connected to the air pressure sensor 322.

Step 21 and step 22 can be performed manually or by a mobile device such as a robotic arm. The mobile device may be part of the detection device 32 or another independent device.

In step 23, the gas pipeline 321 inflates each air bag 312 according to the predetermined air pressure.

In step 24, the air pressure sensor 322 and the display 323 detect and display whether the air pressure in each air bag 312 is normal.

In detail, the air pressure sensor 322 can sense the air pressure in each air bag 312 after the air bags 312 are inflated, and the display 323 can display the value of the air pressure in each air bag 312.

For example, the display 323 can be a display screen or a meter to display the value of the air pressure in each air bag 312.

In one embodiment, for the air pressure in each air bag 312, the display 323 can select one of a plurality of different display modes to display the value of the air pressure according to whether the air pressure reaches the predetermined air pressure. For example, the plurality of different display modes are to display the value of the air pressure in a plurality of different colors. For another example, the display 323 can display in green to show that the air pressure value has reached the predetermined air pressure (that is, the normal air pressure value), and the air pressure value that does not reach the predetermined air pressure (that is, the abnormal air pressure value) is displayed in red, thereby detecting and displaying whether the air pressure in each air bag 312 is normal.

In addition, the display 323 can issue a warning by displaying text messages, sending electronic messages, and/or making sounds when the air pressure in any air bag 312 does not reach the predetermined air pressure.

In step 25, the height sensor 324 detects whether each testing head 313 is level.

In detail, the height sensor 324 is used to sense the height of each testing head 313. This height refers to the height of each testing head 313 when the electronic element is not grabbed.

For example, for each testing head 313, the height sensor 324 can move horizontally to sense a plurality of heights at a plurality of positions on a plane of the testing head 313 (for example, the uppermost plane 3131 shown in FIG. 3D). As another example, the height sensor 324 may be a digital dial indicator including a probe 3241, and the probe 3241 directly contacts the plane 3131 of the testing head 313 when the height sensor 324 moves horizontally, so as to sense the plurality of heights of the plane 3131.

After obtaining the plurality of heights of the plane 3131, the height sensor 324 can determine whether the testing head 313 is level based on the plurality of heights.

For example, if the plurality of heights are shown as the dotted line 341 in FIG. 3D, and every position on the plane 3131 has the same height, then the testing head 313 is level. On the contrary, if the plurality of heights, as shown by the dotted line 342 in FIG. 3D, present different heights at different positions on the plane 3131, then the testing head 313 is tilted rather than level.

Alternatively, the height sensor 324 can calculate the difference value of the plurality of heights, and then determine whether the testing head 313 is level based on the difference value.

In one embodiment, when the height sensor 324 determines that any testing head 313 is not level, it can issue a warning by displaying text messages, sending electronic messages, and/or making sounds.

In step 26, based on the air pressure of each air bag 312 and the height of each testing head 313, determine whether the testing mechanism 31 is qualified.

In detail, if the air pressure in each air bag 312 has reached the aforementioned predetermined air pressure, and each testing head 313 is level, the testing mechanism 31 is determined to be qualified. On the contrary, if the air pressure in at least one air bag 312 does not reach the predetermined air pressure, or at least one testing head 313 is not level, the testing mechanism 31 is determined to be unqualified.

For example, among the four air bags 312 shown in FIG. 3D, the three left air bags 312 have not leaked. Therefore, the air pressure in each of the three left air bags 312 reaches the predetermined air pressure, and the corresponding three left testing heads 313 are all level. In addition, the rightmost air bag 312 has leaked. Therefore, the air pressure in the rightmost air bag 312 does not reach the predetermined air pressure, and the corresponding rightmost testing head 313 is not level. Accordingly, the testing mechanism 31 in FIG. 3D is tested as unqualified.

In one embodiment, step 26 may include subsequent processing of the qualification determination of the testing mechanism 31. Specifically, if the testing mechanism 31 is qualified, then the testing mechanism 31 is installed back to the aforementioned testing machine to perform power-on testing of the electronic element. On the contrary, if the testing mechanism is unqualified, then the air bag 312 that has not reached the predetermined air pressure is replaced, or the entire testing mechanism 31 is replaced, and then the above-mentioned detection method shown in FIG. 2 is performed on the replaced testing mechanism 31.

Step 26 can be performed manually, or by the detection device 32, or by a mobile device such as a robotic arm. The mobile device may be part of the detection device 32 or another independent device.

To sum up, the detection device and detection method of the testing mechanism according to the present disclosure can detect whether the air bag pressure of the testing mechanism is normal, and can detect whether the testing head of the testing mechanism is level, so as to determine whether the testing mechanism can accurately conduct the power-on testing of the electronic element, thereby solving the shortcomings in that a warning cannot be issued and thus the power-on testing is inaccurate when the air bag leaks or the testing head is tilted in the conventional testing mechanism. In addition, in one embodiment, the detection device and detection method of the testing mechanism according to the present disclosure can increase the testing yield of the electronic element by approximately 10%.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

What is claimed is:

1. A detection device for a testing mechanism, wherein the testing mechanism includes an air bag and a testing head, the testing head is used to grab an electronic element, and the air bag is used to push the testing head when inflated to press the electronic element into a test socket of a testing machine to perform a power-on testing of the electronic element, the detection device comprising:
a gas pipeline for inflating the air bag;
an air pressure sensor for sensing an air pressure in the air bag;
a display for displaying a value of the air pressure; and
a height sensor for sensing a height of the testing head.

2. The detection device of claim 1, wherein the display is further used to select one of a plurality of different display modes to display the value of the air pressure according to whether the air pressure reaches a predetermined air pressure.

3. The detection device of claim 2, wherein the plurality of different display modes display the value of the air pressure in a plurality of different colors.

4. The detection device of claim 2, wherein the display is further used to issue a warning when the air pressure does not reach the predetermined air pressure.

5. The detection device of claim 1, wherein the height of the testing head is a height of the testing head when the electronic element is not grabbed.

6. The detection device of claim 1, wherein the height sensor is further used to move horizontally to sense a plurality of heights at a plurality of positions on a plane of the testing head, and determine whether the testing head is level based on the plurality of heights.

7. The detection device of claim 6, wherein the height sensor calculates a difference value of the plurality of heights, and then determines whether the testing head is level based on the difference value.

8. The detection device of claim 6, wherein the height sensor includes a probe, and the probe directly contacts the plane of the testing head when the height sensor moves horizontally, so as to sense the plurality of heights of the plane.

9. The detection device of claim 6, wherein the height sensor is further used to issue a warning when it is determined that the testing head is not level.

10. A detection method for a testing mechanism, wherein the testing mechanism includes an air bag and a testing head, the testing head is used to grab an electronic element, and the air bag is used to push the testing head when inflated to press the electronic element into a test socket of a testing machine to perform a power-on testing of the electronic element, the detection method comprising:
inflating the air bag;
sensing an air pressure in the air bag;
displaying a value of the air pressure; and
sensing a height of the testing head.

11. The detection method of claim 10, further comprising:
selecting one of a plurality of different display modes to display the value of the air pressure according to whether the air pressure reaches a predetermined air pressure.

12. The detection method of claim 11, wherein the plurality of different display modes display the value of the air pressure in a plurality of different colors.

13. The detection method of claim 11, further comprising:
issuing a warning when the air pressure does not reach the predetermined air pressure.

14. The detection method of claim 10, wherein the height of the testing head is a height of the testing head when the electronic element is not grabbed.

15. The detection method of claim 10, further comprising:
sensing a plurality of heights at a plurality of positions on a plane of the testing head; and
determining whether the testing head is level based on the plurality of heights.

16. The detection method of claim 15, further comprising:
calculating a difference value of the plurality of heights; and
determining whether the testing head is level based on the difference value.

17. The detection method of claim 15, further comprising:
moving a probe horizontally to directly contact the plane of the testing head, so as to sense the plurality of heights of the plane.

18. The detection method of claim 15, further comprising:
issuing a warning when it is determined that the testing head is not level.

19. The detection method of claim 10, wherein the detection method is performed by a detection device of the testing mechanism, and, before inflating the air bag, the detection method comprising:
disassembling the testing mechanism from the testing machine; and
installing the testing mechanism on the detection device.

20. The detection method of claim 19, wherein, between the disassembling and the installing of the testing mechanism, the detection method further comprising:
turning the testing mechanism upside down.

21. The detection method of claim 19, further comprising:
determining whether the testing mechanism is qualified based on the air pressure of the air bag and the height of the testing head;
installing the testing mechanism back to the testing machine when the testing mechanism is qualified; and
replacing the air bag or the testing mechanism, and then performing the detection method on the replaced testing mechanism when the testing mechanism is not qualified.
